(19) United States
(12) Patent Application Publication
(10) Pub. No.: US 2018/0203144 A1
(43) Pub. Date: Jul. 19, 2018

(54) Interferometric Microseismic Imaging Methods and Apparatus

(71) Applicant: OPTASENSE, INC., Santa Clara, CA (US)

(72) Inventors: Martin Karrenbach, Brea, CA (US); William Allen Bartling, Bakersfield, CA (US); Stephen Patrick Cole, Palm Springs, CA (US)

(73) Assignee: OPTASENSE, INC., Santa Clara, CA (US)

(21) Appl. No.: 15/574,587

(22) PCT Filed: May 20, 2016
(86) PCT No.: PCT/GB2016/051453

§ 371 Date: Nov. 16, 2017

Related U.S. Application Data
(60) Provisional application No. 62/164,376, filed on May 20, 2015.

(51) Int. Cl. G01V 1/28; G01V 1/36; G01V 1/37; G01V 1/42; G01V 1/30; G01D 5/353

(52) U.S. Cl. CPC G01V 1/288; G01V 1/366; G01V 1/375; G01D 5/35306; G01V 1/303; G01D 5/3538; G01V 1/42

(57) ABSTRACT

Methods and apparatus for interferometric seismic imaging and creation of a high-resolution three-dimensional seismic volume in proximity to a wellbore are described. In contrast to current methods that deliver positions of microseismic events using a small fraction of the microseismic wavefield, the present invention provides for the analysis of a full microseismic wavefield. In a preferred embodiment, the method includes creating a planar image slice and/or corridor between the location of one or more microseismic events and one or several sensor arrays to produce a multitude of azimuthally orientated planar image slices and/or corridors. The method further includes adding the planar image slice and/or corridor contributions to create a single three-dimensional volume for analysis and rendering.

This application is related to the field of geophysical imaging. More particularly, the application relates to methods and apparatus for microseismic and passive seismic monitoring, as well as high-resolution imaging of subterranean formation regions.

Seismic data is used in many, e.g. scientific, fields to monitor underground events in subterranean rock formations. Monitoring of seismic waves can be performed to investigate these underground events. Seismic waves are waves of energy that travel through the Earth's layers, and are a result of sources or events that produce low-frequency acoustic energy. Such events include, for example, earthquakes, explosions, and volcanoes. Such events also include what are known as microseismic events, that include events which are caused when human activities such as mining or oil and gas production change the stress distribution or the volume of a rock mass. Microseismic events may also be defined to include small-scale earthquakes or other natural events that act as subsurface sources.

Typically, the seismic waves emitted by microseismic events occur at much higher frequencies than those of natural earthquakes and generally fall within the acoustic frequency range of 200 Hz to more than 2000 Hz. However, where a sensor has sufficient sensitivity, microseismic events may be detected at levels below 200 Hz, e.g., 10 Hz, and levels above 2000 Hz. Seismic waves are generally divided into two categories: body waves and surface waves. Body waves travel through the interior of the Earth, whereas surface waves travel across the Earth's surface. Body waves, of particular interest here, are further divided into primary waves (“P-waves” or “P waves”) and secondary waves (“S-waves” or “S waves”). P-waves are compressional waves, longitudinal in nature. S-waves are shear waves, transverse in nature. Many other types of seismic waves exist and are well known in the art.

Existing microseismic analysis techniques are used in an attempt to locate the sources of microseismic activity caused by fluid injection or hydraulic fracturing. In certain formations, particularly many associated with oil and gas reservoirs, formation permeability is too low to produce gas or oil at economic rates and quantities. Hydraulic fracturing addresses this problem by intentionally creating fractures in the rock formations that provide additional conduits to enhance gas or oil flow. Fluid is pumped into wells at sufficient pressure to fracture the formation rock. The fluid also transports a propping agent (also known as “proppant”) into the fracture. The proppant, usually sand or ceramic pellets, settles in the fractures to help keep the fracture open after the fracturing operation ceases and high injection pressures are removed. Production of gas or oil from the formation is then accelerated due to improved capability for flow within the reservoir. Similarly, water flooding of largely expended oil fields seeks to push oil to other wells where it is produced. Fractures are often created in this process that direct the oil, or the water, in a potentially unknown direction. In this process, water, or possibly steam, is used to increase pressure and/or temperature to displace the oil to a more favorable production location.

Microseismic detection offers an opportunity to monitor hydraulic fracturing, water flooding techniques, or steam flooding techniques and the like to map, for example, created fractures. A hydraulic fracture induces an increase in the formation stress proportional to the net fracturing pressure as well as an increase in pore pressure due to fracturing fluid leak off. Large tensile stresses are formed ahead of the crack tip, which creates large amounts of shear stress. Both mechanisms, pore pressure increase and formation stress increase, affect the stability of planes of weakness (such as natural fractures and bedding planes) surrounding the hydraulic fracture and cause them to undergo shear slippage. These shear slippages are analogous to small earthquakes along faults.

Standard borehole microseismic analysis techniques detect P-wave and S-wave arrival times. From these arrival times, the analyst is able to determine the location of origin for each microseismic event. Additional event attributes can be derived from the recorded wave field information, such as magnitude, moment tensor components and fault plane solutions. While approaches exist to determine the source location by imaging/stacking of the P or S wave field, these approaches do not create an image, two-dimensional or three-dimensional, of the surrounding geologic structure. In essence, these methods simply provide a map of the temporal and spatial location of the microseismic events to estimate the extent of the fracture propagation.

For example, Fei, et al, U.S. Pat. Application No. US 2014/0050050, discloses a method for determining microseismic source location using Green's functions. The goal of the method is to estimate the location of microseismic events from passive seismic data where the source locations are unknown. The disclosure of Fei does not teach a method for creating a two-dimensional or three-dimensional image of the subsurface geology. Fei merely provides an estimated map of microseismic event locations.

Liang et al, U.S. Pat. No. 8,218,394 discloses a method for imaging the Earth's subsurface using interferometry applied to passive seismic data recorded on the earth's surface. Liang's disclosure follows established theory from Claerbout and others that by processing passive data from unknown sources with a surface array, the impedance structure of the earth (an image of the subsurface geology) may be obtained. Because the data are recorded on the surface and the passive seismic sources are of unknown strength and quality, such methods have traditionally generated very poor images of the subsurface. Surface analyses typically fail to include S-wave components due to the attenuation of the S-wave signal through the overburden of the formation.

Gulati, U.S. Pat. No. 8,649,980 discloses systems and techniques for improving signal-to-noise ratios in seismic acquisitions and for improving microseismic survey analysis techniques for hydraulic fracture monitoring including interferometric acquisition. In particular, Gulati relies on quantum mechanical concepts and processes such as spin, tunneling, and quantum resonance interferometry. These are physical concepts that describe particle interactions at the subatomic level due to forces that are not associated with seismic wave propagation in the earth. There are no known indications that the teachings of Gulati have been used to create subsurface imagery from microseismic events.

The development of natural resources to produce sufficient energy production independent of foreign sources, is a recurring source of debate and dispute. Most recently, the development of oil and natural gas produced from source rock in shale formations has simultaneously sparked great hope of new, independent energy resources while fomenting significant controversy concerning the drilling and development practices used to produce the oil and natural gas. For example use of horizontal drilling and hydraulic fracturing within the Marcellus Shale reservoir located throughout Ohio, Pennsylvania and New York has created severe quarrels as to whether the drilling practices are contaminating precious groundwater used for drinking purposes. Consequently, there is a stark and immediate need for drilling and fracturing monitoring technology to ensure that the oil and natural gas production activity can continue without causing contamination of water supplies.

Various attempts have been made to create high-resolution mapping of subsurface microseismic events using surface arrays. Unfortunately, the existence of overburden interference and attenuation of P and S wave fields through the overburden results in lower resolution and less confident mapping of the formation.

In light of the aforementioned considerations and limitations of existing and proposed approaches, there exists an unmet desire for a method that can produce two-dimensional and/or three-dimensional seismic volume imaging data at high resolution from microseismic events. In addition, a method that can analyze the full microseismic wavefield, including both P-waves and S-waves, and importantly, use that analysis to create a high-resolution three-dimensional seismic volume within proximity of a wellbore would be advantageous. A method is further desired that could provide a seismic volume of sufficient resolution to allow the determination of important details of reservoir characters. Still further, such a method is desired that could be used to continuously monitor reservoir parameters and performance from passive microseismic data recorded in an active oil or gas field. Additionally, a method that does not require any active sources (such as vibroseis or dynamite) to access wave fields of sufficient magnitude to image the subsurface would be beneficial. Likewise, there exists a desire for a system capable of providing a final three-dimensional seismic volume deliverable in a standard format that can be subsequently analyzed in commercial seismic interpretation software, and interpreted, processed and integrated with other reservoir data as a standard seismic volume, thus requiring no special software or high learning curve to use the data associated with the three-dimensional seismic volume.

Embodiments of the present invention provide an interferometric method for imaging the Earth's subsurface using microseismic events and/or passive seismic events recorded by borehole sensors. One or more embodiments of the invention relate to methods of seismic imaging wherein a sensing array is used to record a data set corresponding to a microseismic event wave field from at least one microseismic event. The data set is subsequently processed according to the method to generate a three-dimensional volume, wherein the processing comprises applying an interferometric three-dimensional seismic volume creation algorithm to the data set. The three-dimensional seismic volume corresponds to a volume of the Earth between an origin of the microseismic event wave field and the sensor array.

Thus according to the present invention there is provided a method for interferometric microseismic imaging of the Earth's subsurface, comprising:

(a) taking a data set corresponding to a recording by a sensor array of a microseismic event wave field generated by a microseismic event in the subsurface; and
(b) processing the data set to generate a microseismic image slice for at least one microseismic event wave field;
wherein said processing comprises:
identifying arrival of a P wave and arrival of an S wave in the microseismic event wave field and forming a respective P wave field and an S wave field; and
propagating the P wave field and S wave field away from the location of the sensor array and applying an interferometric imaging condition between the P wave field and the S wave field at a plurality of grid points to form an image of the subsurface.

The method thus records the microseismic event wave field using the sensor array which may be a wide aperture sensor array, i.e. has a relatively large spatial extent, and thus a data set corresponding to a significant portion or substantially all of the event wave field may be recorded. The P and S waves are separately identified and a P wave and S wave field formed. Components of the P and S waves fields are then used with an interferometric imaging condition to propagate the wave fields away from the location of the sensor array, e.g. in a computational grid. By applying the interferometric imaging condition between the P and S wave fields the portion of the subsurface between the sensor array and the source of the microseismic wave field, i.e. the location of the microseismic event, is imaged—forming an image slice of the subsurface.

The method is extensible and scalable to create one or more two-dimensional planar image(s) (slices), one or more three-dimensional corridor(s) and/or a three-dimensional image volume from one or several data sets collected from one or several sensor arrays collecting wave field information from one or a plurality of microseismic events.

In one version, the method may make use of standard geophones. Additionally or alternatively the method may use distributed fiber optic sensors. Within a targeted area, the method may be applied to create two-dimensional planar images (slices), three-dimensional corridors and/or three-dimensional seismic volumes. The images, corridors and volumes may be created having substantially higher resolution than existing methods.

In contrast to certain other approaches, the method of the present disclosure does not require an active energy source, such as vibroseis or dynamite. Embodiments can provide a bridge between near-field measurements delivered by distributed acoustic sensing and other in-well technologies, and, the far-field effects of operations in one or more wellbores. As just one example, using the method of the present disclosure, an analyst can assess how a steam flood or water flood operation might affect a reservoir away from a well in the hydrocarbon-bearing formation. One deliverable from the interferometric method described herein may include the provision of a three-dimensional seismic volume structured and configured for input into industry standard and commercially available seismic interpretation software. The combination of the three-dimensional seismic volume created by the method of one example of the invention, in conjunction with the use of known interpretation tools, allows analysts to immediately make use of the data generated by the interferometric methods according to the embodiments.

The interferometric method of the present disclosure can provide an optimal approach for supporting life-of-field analyses. For example, the results associated with application of the method can be applied to and correlated with other life-of-field technologies, such as temperature and flow measurements, to optimize the cost of development/production and maximize economic recovery. Thusly, implementations of the present invention may directly influence metrics associated with finding and development of oil fields, enhancing overall economic outcomes.

The method is extensible to the assessment and analysis of unconventional oil and gas resources on a global basis. Unconventional resources may include those formations having low permeability where artificially-induced fractures of the formation are necessary to create economic production. In particular, the method is applicable to assist oil and gas operators in selecting formation zones most likely to produce hydrocarbons in economic quantities while avoiding investment in formation zones that do not have clear and quantifiable return on investment benefits.

Microseismic events, in one application, are small dislocations of rock material recorded during hydraulic fracturing operations. The method discloses the use of recordings of microseismic events to create one or more data sets that are processed to image the surrounding geologic structure. The method provides for analysis of one or more data sets associated with the full microseismic wavefield and uses that analysis to create a higher-resolution three-dimensional seismic volume to determine with detail the character of the reservoir and the geologic formation. The analysis can be applied in a temporal sequence to each stage of hydraulic fracturing or continuously, allowing the observation and assessment of time-variable effects.

A method for interferometric microseismic imaging of the earth's subsurface, according to one aspect of the invention, comprises recording a microseismic event wave field, typically by sensors of one or more sensor arrays placed in one or several boreholes. The sensors record the microseismic event wave field originated by any subsurface source mechanism, e.g., natural earthquakes, hydraulic fracturing, gas injection, wastewater injection, water flooding, CO2 sequestration, reservoir depletion, sinkhole development, foundational settling, other structural changes and other naturally occurring and/or artificially induced scenarios. One or more data sets based on the recorded wave field are processed to determine the location of origin of each microseismic event. The process is repeated for each recorded microseismic event and a plurality of microseismic event locations are determined.

In other aspects of the invention, the method may be applied to previously recorded data provided as a data set for processing according to the method of the invention. Additionally, the method may be applied by a first party to data recorded by another party. Still further, although preferably described herein as applicable for processing data gathered from sensor arrays placed in boreholes, additional embodiments of the invention are likewise applicable to data gathered via surface sensor arrays, and/or surface sensor arrays in combination with borehole sensor arrays. Additionally, the method may be used to assess data gathered from sensor arrays deployed on tubing, coiled tubing or via wireline.

Once obtained, the data set for each recorded wavefield associated with each microseismic event is propagated laterally away from the location of the sensor array toward an initial estimated microseismic event location. In some embodiments the P wave field and S wave field may be enhanced by signal filtering. Interferometric imaging may then be applied to image scattering of microseismic energy off geologic structures in the Earth's subsurface to characterize the geologic structures and the formation.

For each recorded microseismic event, a narrow three-dimensional corridor or a single two-dimensional planar image (slice) may be generated. The orientation, azimuth and shape of the corridor or slice may be determined by estimating the location of each microseismic event and/or its probability distribution. The microseismic event location may be estimated using travel time and particle motion information, that is the microseismic event location may be estimated based on the times of arrival of the P wave and the S wave and a velocity model. The method may involve estimating a likely event azimuth, i.e. an azimuth of the most likely location of the microseismic event. Estimating a likely event azimuth may involve computing a most likely event azimuth from arrival polarization information. An image slice may be based on a computation grid oriented along the most likely event azimuth for a particular microseismic event. An image corridor is a three-dimensional computational volume where two axes are oriented along the most likely event azimuth and the third axis is perpendicular to the other two axes.

For example, for a monitoring program with vertical borehole recording geometries, the planar image slices may be slices parallel to the plane encompassing the sensor array and the likely microseismic event location. Each microseismic event location is determined within some probability distribution of the likely event location. Thus, a plurality of detected microseismic events leads to a plurality of estimated event locations and a plurality of vertical image slices or corridors oriented along a plurality of azimuths.

These image slices may be combined using a three-dimensional seismic volume creation algorithm. This may involve, for example, adding interpolated and normalized individual narrow three-dimensional corridors or two-dimensional slice image contributions into an aggregate three-dimensional volume to produce a three-dimensional image volume from the data set associated with an aggregate of the plurality of microseismic event locations and their associated wave fields. Optional processing may be performed on the resulting data set and image volume, including applying optional image smoothing, optional data infill, and optional image filtering to highlight geologic features and reduce potential imaging artifacts. One or more three-dimensional seismic volumes associated with the optional processing may be generated to support comparative analysis. The resulting highly resolute and extensive three-dimensional seismic volume(s) may be analyzed and interpreted using standard seismic interpretation methods and software, such as SMT's KINGDOM SUITE, LANDMARK's DECISIONSPACE or the open-source seismic interpretation package OPENDTECT.

Each three-dimensional seismic volume image may be rendered for viewing by a user on a visual medium such as a computer display screen, a holographic projection, a two-dimensional projection, a three-dimensional projection using three-dimensional technology and/or on printed media. The resulting three-dimensional images may be co-registered, co-rendered and analyzed together with other seismic data, reservoir data and geologic information. Further, various reservoir characteristics (such as brittle and ductile zones, efficiency of fracturing zones and stages, small scale faulting/folding, and fracturing pathways) may be analyzed using the data set associated with the three-dimensional seismic volume image generated according to the method of the invention. Additionally, in another aspect, the interferometric method according to the invention may be used to facilitate calibration of flow measurements in the borehole with a three-dimensional image volume generated in a target area at a hydraulic fracturing stage location. The method may then be used to extrapolate the interpretation associated with the flow measurements further away from the treatment borehole into the local formation at high resolution.

Aspects also relate to computer readable instructions or software code stored on a non-transitory computer readable medium, the instructions or code comprising instructions for causing a computing device to perform the method of any of the variants described above.

Aspects also relate to a microseismic imaging apparatus comprising:
a memory for storing a data set corresponding to a recording by a sensor array of a microseismic event wave field generated by a microseismic event in a subsurface area of interest; and
a processor configured to processing the data set to generate a microseismic image slice for at least one microseismic event wave field;
   wherein said processing comprises:
identifying arrival of a P wave and arrival of an S wave in the microseismic event wave field and forming a respective P wave field and an S wave field; and
propagating the P wave field and S wave field away from the location of the sensor array and applying an interferometric imaging condition between the P wave field and the S wave field at a plurality of grid points to form an image of the subsurface.

The processor may be arranged to implement the method in any of the variants described above.

Also provides is a system for interferometric microseismic imaging of the Earth's subsurface comprising: microseismic imaging apparatus as described above; and and at least one sensor array having an array of sensing elements deployed in borehole in the subsurface area of interest to record said data set.

In another aspect a method of seismic imaging comprises: (a) recording, using a sensor array, a data set corresponding to a microseismic event wave field from at least one microseismic event; and (b) processing said data set to generate a three-dimensional volume, wherein said processing comprises applying an interferometric three-dimensional seismic volume creation algorithm to said data set.

In a further aspect a method of seismic imaging comprises: (a) taking a data set corresponding to a microseismic event wave filed detected by a sensor array; and (b) processing said data set to generate a three-dimensional volume, wherein said processing comprises applying an interferometric three-dimensional seismic volume creation algorithm to said data set.

A further aspect provides a method for interferometric microseismic imaging of the Earth's subsurface, comprising:

(a) using one or more sensors to record a microseismic event wave field;
(b) creating a data set based on the recording of the microseismic event wave field;
(b) applying an interferometric three-dimensional seismic volume creation algorithm to the data set; and
(d) generating a three-dimensional seismic volume.

The method of this aspect may further comprise the step of analyzing and interpreting the three-dimensional seismic volume and/or the step of rendering a three-dimensional seismic volume image. The three-dimensional seismic volume may correspond to a volume of the Earth between an origin of the microseismic event wave field and the sensor array.

The interferometric three-dimensional seismic volume creation algorithm may further comprises the steps of:

(a) defining a desired output volume with a given extent, orientation and coordinate system to encompass a desired image target area;
(b) for one or more input planar image slices in the local imaging coordinate system for an output volume, interpolating all values of the one or more input planar image slices at each of the local imaging grid points values onto the output volume grid values;
(c) adding the interpolated values; and
(d) at each output grid point, accumulating the associated amplitude values.

The method may further comprise the step of, for one or more input image corridors in the local imaging coordinate system for an output volume, interpolating all values of the one or more input image corridors at each of the local imaging grid points values onto the output volume grid values. All parameters associated with the three-dimensional seismic volume creation algorithm may be initialized with zero values to create an initial empty three-dimensional volume. Optionally amplitude weights may be applied to normalize the output volume. Optionally an actual or smoothed hit count normalization may be applied when all image contributions are added to the output volume.

The method may further comprising one or more of the optional processing steps of:

(a) applying optional image smoothing;
(b) applying optional data infill; and
(c) applying optional image filtering to highlight geologic features.

These and other features, aspects and advantages of various embodiments of the present invention will become better understood with regard to the following description, appended claims, and accompanying drawings where:

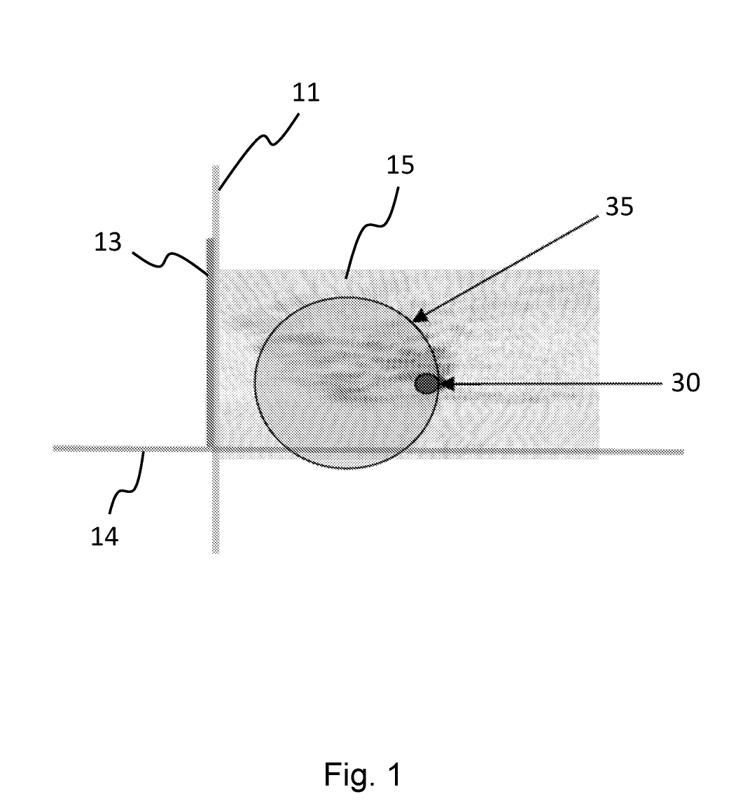

FIG. 1 is an elevation view of a vertical planar slice of the formation generated according to the method of the present invention;

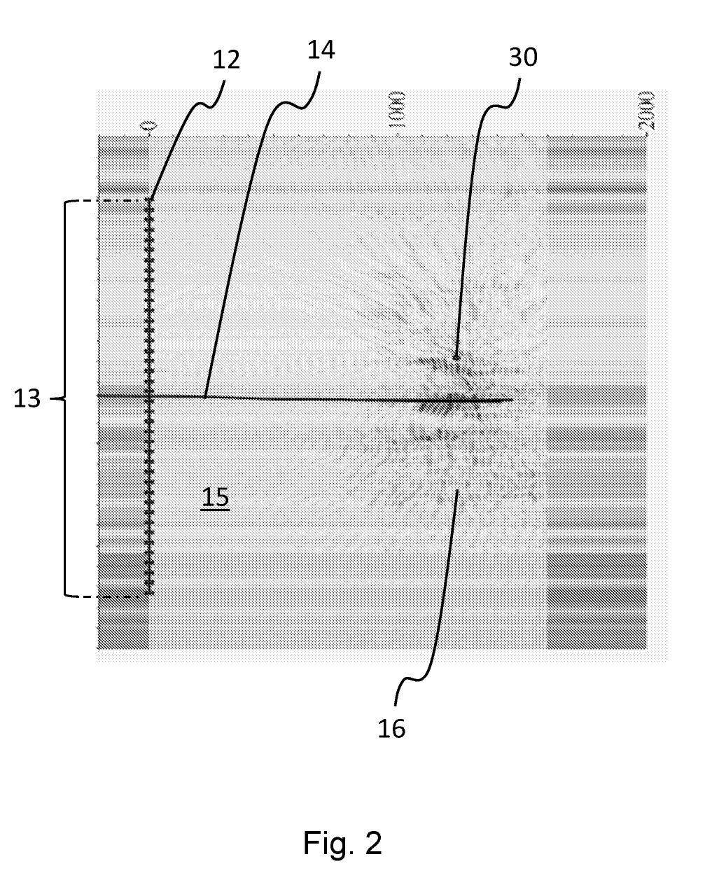

FIG. 2 is an enlarged elevation view of a vertical planar slice of the formation generated according to the method of the present invention;

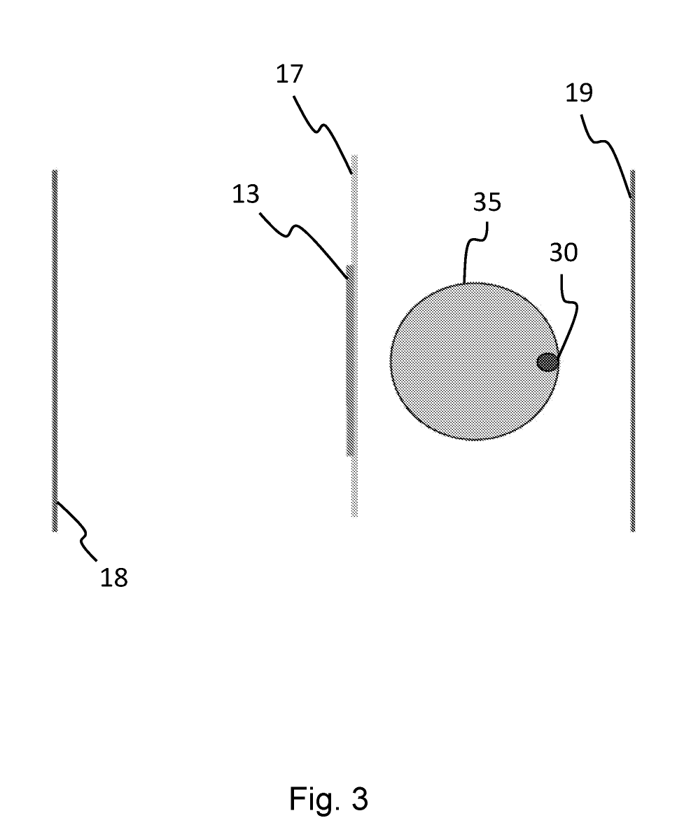

FIG. 3 is a schematic plan or map view of a horizontal planar slice of the formation generated according to the method of the present invention;

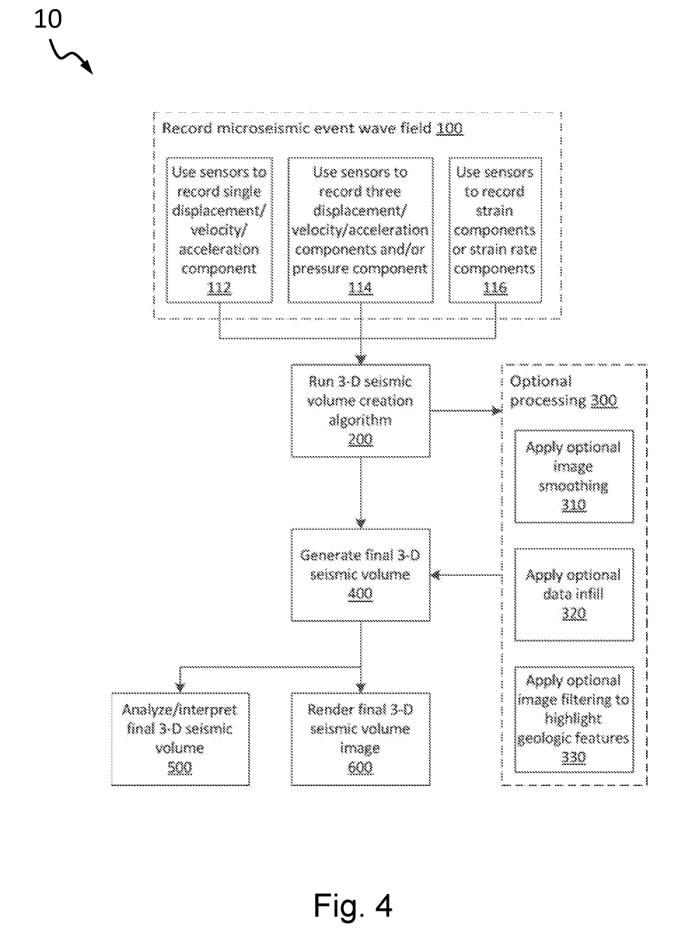

FIG. 4 is a flowchart of the interferometric microseismic imaging method according to the present invention;

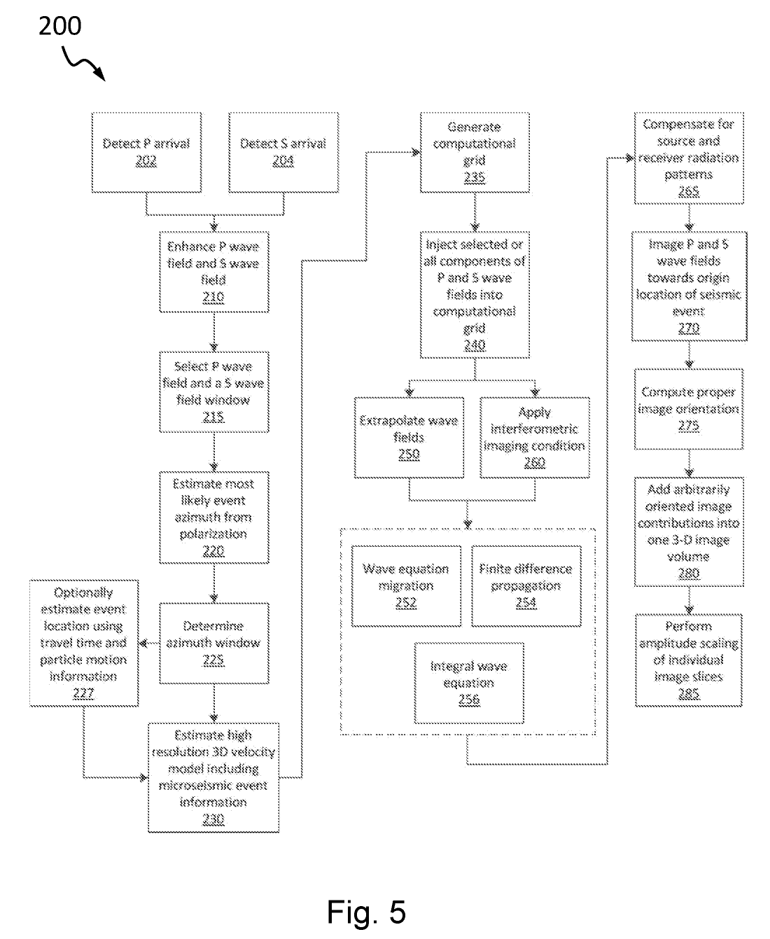

FIG. 5 is a more detailed flowchart of the three-dimensional seismic volume creation algorithm and method according to the present invention;

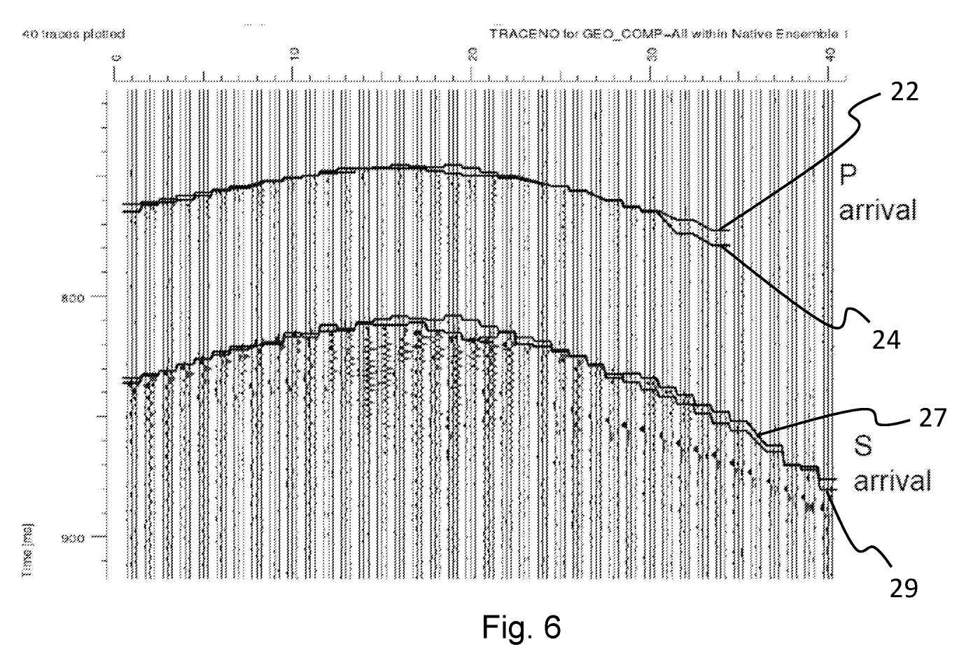

FIG. 6 is an exemplary plot of P-wave and S-wave arrival time data;

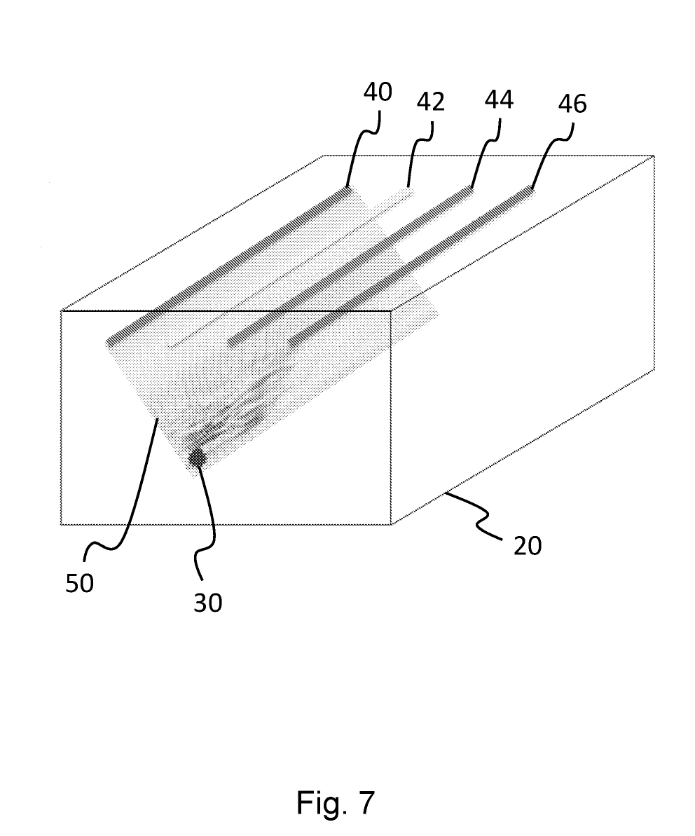

FIG. 7 is an illustration of a first single image plane derived from a single microseismic event and a first sensor array in a three-dimensional volume generated according to an embodiment of the present invention;

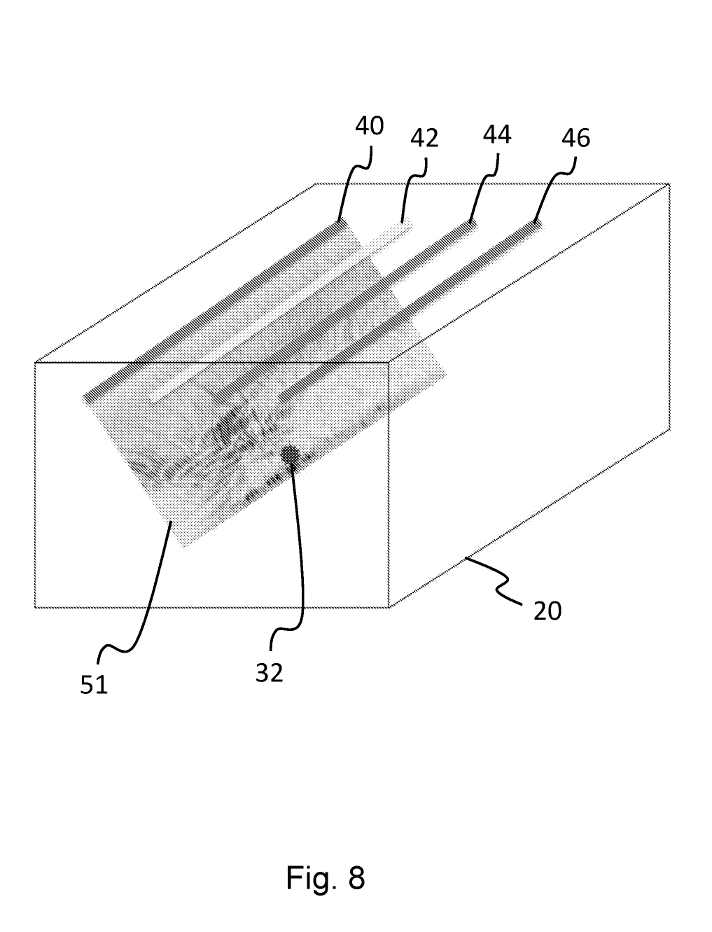

FIG. 8 is an illustration of a second single image plane derived from a second single microseismic event and the first sensor array in a three-dimensional volume generated according to an embodiment of the present invention;

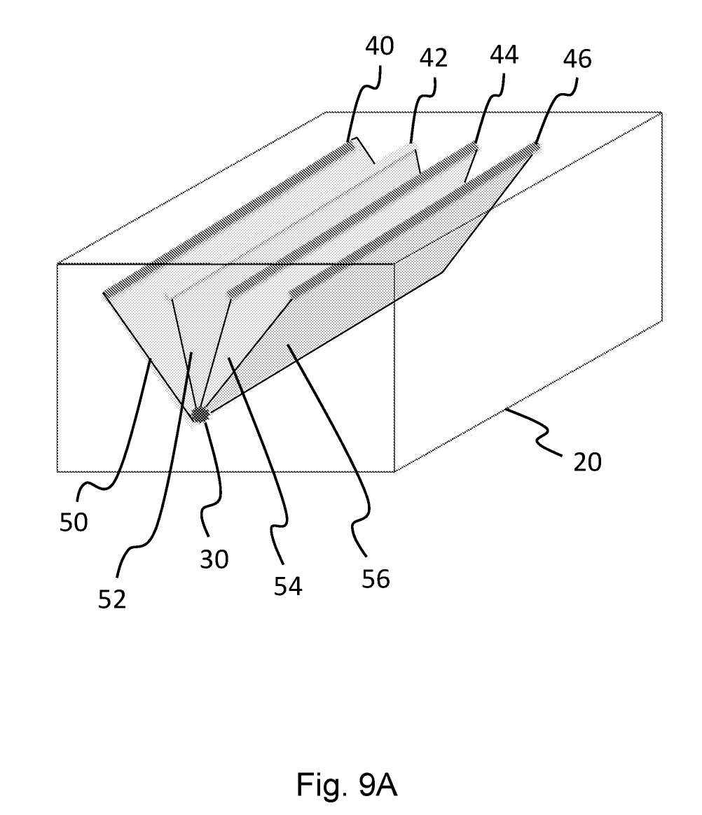

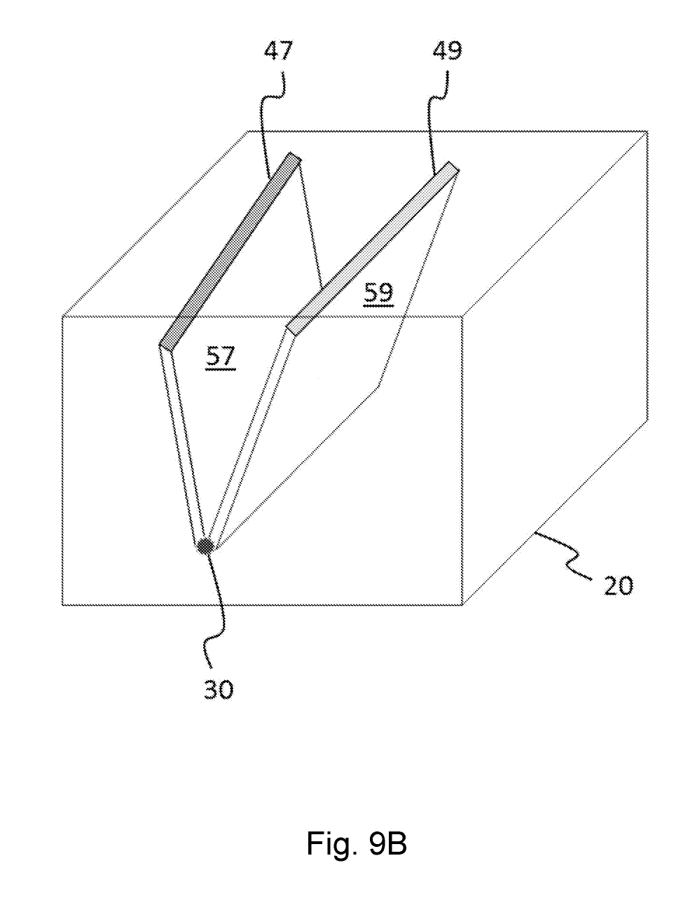

FIG. 9A is a schematic illustration of multiple image planes derived from the single microseismic event of FIG. 7 and multiple sensor arrays in multiple wellbores, according to an embodiment of the present invention;

FIG. 9B is a schematic illustration of two exemplary image corridors derived from the single microseismic event of FIG. 7 and multiple sensor arrays in multiple wellbores, according to an embodiment of the present invention;

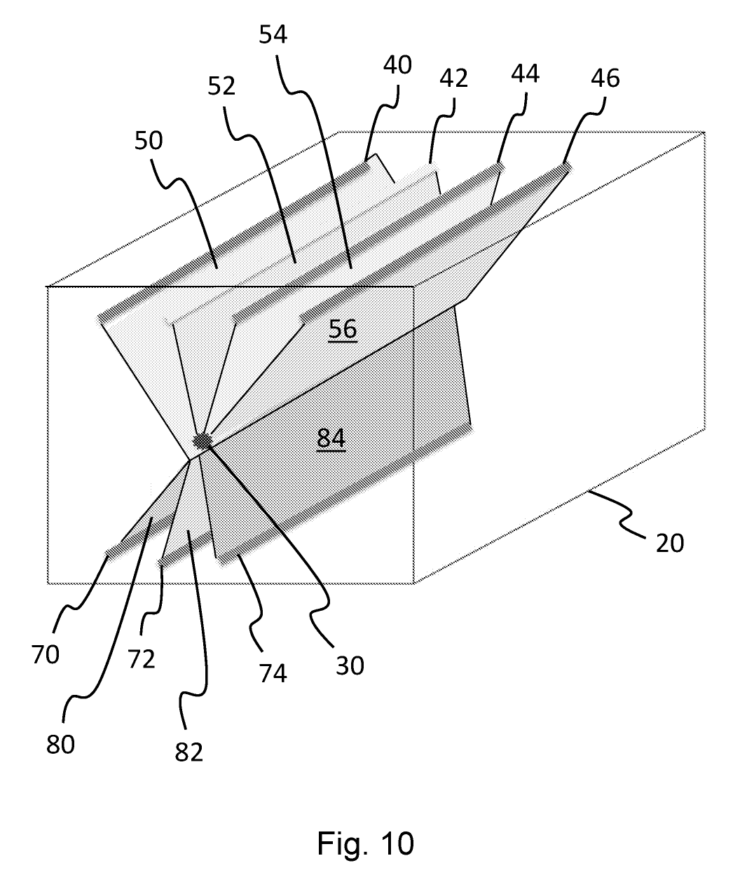

FIG. 10 is an illustration of multiple image planes derived from the single microseismic event of FIG. 7 where multiple sensor arrays are deployed in multiple wellbores in stacked reservoirs, according to an embodiment of the present invention;

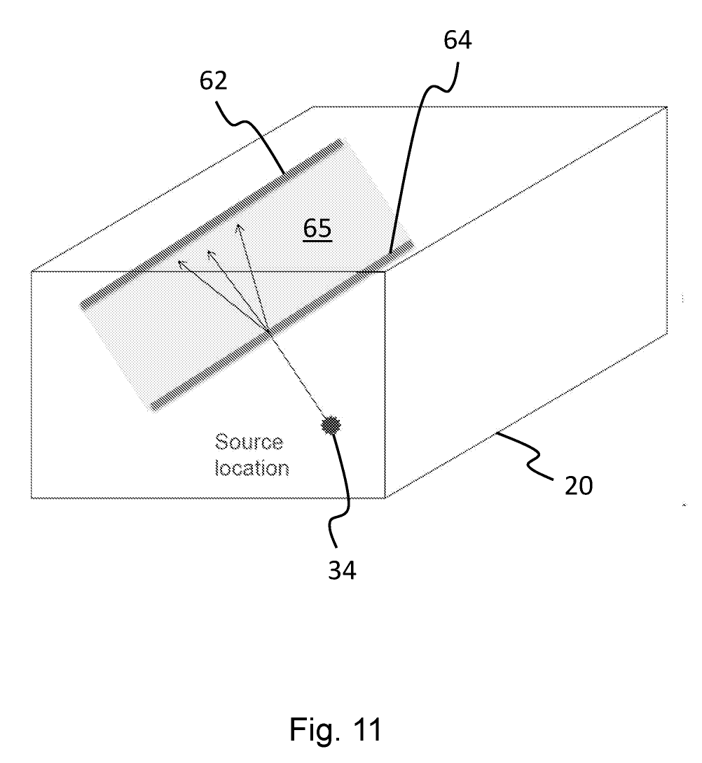

FIG. 11 is an illustration of an image plane derived from a single microseismic event to create a cross-well interpretation, where sensor arrays are deployed in both wellbores and both wellbores and the event are substantially located in a common plane, according to an embodiment of the present invention; and,

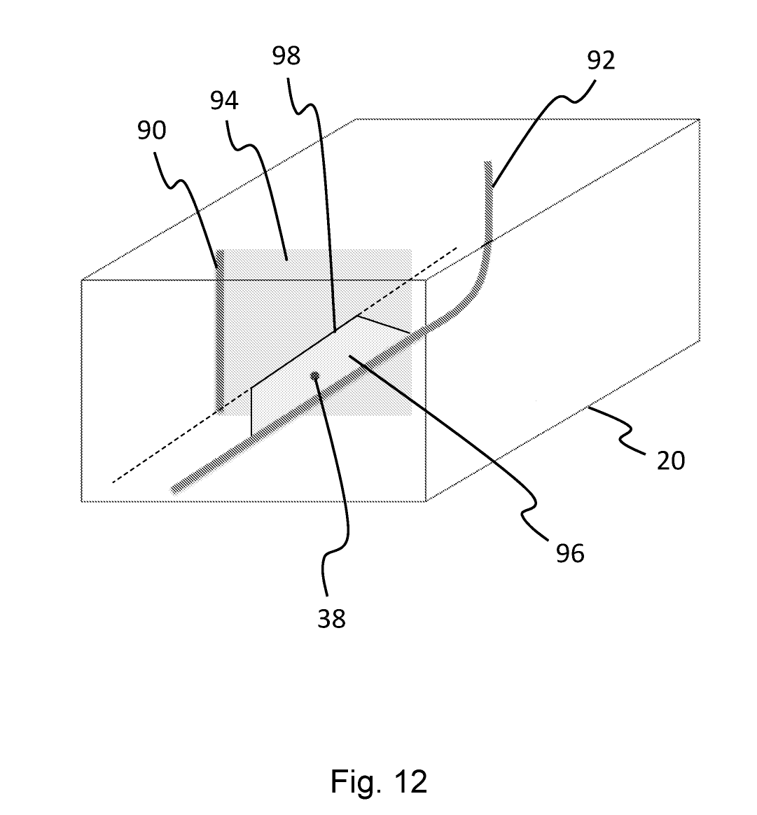

FIG. 12 is an illustration of image planes derived from a single microseismic event and sensor arrays deployed in non-parallel wellbores, according to an embodiment of the present invention

The accompanying drawings numbered herein are given by way of illustration only and are not intended to be limitative to any extent. Commonly used reference numbers identify the same or equivalent parts of the claimed invention throughout the accompanying drawings.

The following description is merely exemplary in nature and is in no way intended to limit the invention, the inventive subject matter, its application, or its uses. Before the inventive subject matter is described in further detail, it is to be understood that the invention is not limited to the particular aspects described, as such may, of course, vary. It is also to be understood that the terminology used herein is for describing particular aspects only, and is not intended to be limiting, since the scope of the present invention will be limited only by the appended claims.

Unless defined otherwise, all technical and scientific terms used herein have the same meaning as commonly understood by one of ordinary skill in the art to which this inventive subject matter belongs. Although any methods and materials similar or equivalent to those described herein can also be used in the practice or testing of the inventive subject matter, a limited number of the exemplary methods and materials are described herein.

Embodiments of the present invention relates to methods and apparatus for monitoring and/or analysis of seismic events in an area of interest. In particular methods may provide a method of imaging of microseismic events.

Referring now to FIG. 1, an exemplary view of the creation of a vertical planar image slice 15 according to the interferometric method 10 of the disclosure is described. In this exemplary view which illustrates a cross section through a location of interest, a substantially vertical observation wellbore 11 includes a sensor array 13, also in a substantially vertical orientation within the wellbore 11. Note that as used herein, the term “observation wellbore” shall be taken to refer to a wellbore or borehole that is provided with a suitable sensor array 13. The observation wellbore may be a borehole that has been drilled specifically to allow the sensor array to be deployed in a desired location or may be an existing wellbore, e.g., of an existing production well, injection well or other similar borehole that has been provided with a suitable sensor array 13. In this example a horizontal wellbore 14 for fracturing a formation runs somewhat transversely to the vertical observation wellbore 11. A microseismic event 30 is created during a hydraulic fracturing operation. The data collected by the sensor array 13 is processed to create a planar image slice 15 having a targeted image area 35.

FIG. 2 provides another exemplary view of the creation of a vertical planar image slice 15 according to the invention. In this example, the vertical sensor array 13 extends above and below the plane of the horizontal frack well 14. A microseismic event 30 creates a complex wave field 16 that is collected by the sensor array 13 and processed to generate the two-dimensional planar image slice 15.

The sensor array 13 comprises a plurality of sensors or sensing elements/portions 12. The sensors 12 are the sensing elements of the sensing array, with the sensor array 13 being operable in use to produce a respective measurement signal for each sensor element of the sensing array. In some embodiments the sensor array 13 may comprise an array of individual sensor elements such as analog geophones, digital geophones and any other similar sensor able to record seismic or microseismic wave fields. Additionally or alternatively the sensor array may comprise on or more The sensors 12 may be accelerometers or other sensing devices response to motion, velocity or acceleration and applicable for use in a seismic data acquisition scenario. Additionally or alternatively the sensor array may comprise on or more distributed downhole fiber optic sensor, for example such as described in GB2,442,745 or WO2012/137022. As will be understood by one skilled distributed fiber optic sensing for detecting dynamic strains or pressure variation, sometimes referred to distributed acoustic sensing (DAS), is a known technique. In such a distributed fiber optic sensor an optical fibre is deployed, e.g. down a wellbore, as a sensing fibre and repeatedly interrogated with electromagnetic radiation to provide sensing of acoustic activity along its length. Typically one or more input pulses of coherent radiation are launched into the optical fibre. By analysing the radiation backscattered from within the fibre, especially coherent Rayleigh backscatter, the fibre can effectively be divided into a plurality of discrete sensing portions which may be (but do not have to be) contiguous. Within each discrete sensing portion disturbances of the fibre, for instance, strains due to incident seismic waves, cause a variation in the properties of the radiation which is backscattered from that portion. This variation can be detected and analysed and used to give a measure of the disturbance of the fibre at that sensing portion. Thus the distributed fiber optic sensor effectively acts as a linear sensing array of sensing portions of optical fibre for sensing dynamic strain. The length of the sensing portions of fibre is determined by the characteristics of the interrogating radiation and the processing applied to the backscatter signals but typically sensing portions of the order of a few meters to a few tens of meters or so may be used. As used herein the term sensing array shall include one or more such distributed fiber optic sensors and for such a sensor array the individual sensing portions can be seen as the sensor elements or sensors 12 of the sensor array.

The microseismic event wave field is defined by measurement of any of: (a) one or more displacement/velocity/acceleration components; (b) one or more pressure components; and (c) one or more strain components/strain rate components.

A data acquisition device and compute platform collects and records data representing seismic signal recordings from the sensors 12. The type of sensor used in recording seismic and microseismic events is not a limit on the scope of the present invention. The type of computer or compute device used to implement the method 10, the type of data storage devices, the type of input/output devices, and/or the type of display devices do not limit the scope of the present invention.

FIG. 3 is another exemplary plan view of an arrangement of wellbores 18, 19 and an observation well 17 in a horizontal configuration. The sensor array 13 is likewise oriented horizontally within the horizontal observation well 17. A microseismic event 30 creates a complex wave field captured by the sensor array and processed to create a horizontal planar image slice 35.

Interferometric measures of P wave and S wave fields recorded on a properly sampled and borehole sensor array 13 are used to image scattering potential in the subsurface. The borehole sensor array 13 in one aspect consists of a large aperture configuration. Ideally, but not necessarily, a borehole sensor array 13 deployed within a borehole extends through, above and below the fracturing zone to capture seismic wave field information. During hydraulic fracturing operations, the source of wave fields are microseismic events 30 caused by a dislocation of rock material in the subsurface during the hydraulic fracturing operation. A complex wave field 16 is radiated in all directions from the source, consisting of direct P, direct S (S1, S2) and scattered, refracted, reflected or mode converted wave field components. The array 13 of seismic sensors 12 registers the various components of each wave field 16 as it passes by the array 13. In the present invention, the geometry of the downhole array 13 is not restricted. Additionally, the method 10 can be applied to single or multiple observation wells.

Turning now to FIG. 4, a top-level flowchart depicting the interferometric microseismic imaging method 10 according to an embodiment is shown. In step 100, a microseismic event wave field is recorded. In step 100, the sensors 12 are configured to record any of: (a) a single displacement, velocity, acceleration component 112, (b) three displacement, velocity, acceleration components and/or a pressure component 114, or (c) strain components/strain rate components 116. The selected recording configuration is dependent on the sensor array 13 configuration. Although addressed herein as responding to microseismic events 30 created by fracturing operations, the sensors 12 may be used to record seismic and microseismic event wave fields 16 originated by any subsurface source mechanism, e.g., natural earthquakes, hydraulic fracturing, water flooding, steam flooding, gas injection, reservoir depletion, waste water injection, CO2 sequestration, sink hole development, volcanic activity, foundation settling, levy weakening, or other structural changes and other naturally-occurring and/or artificially induced scenarios involving subsurface events.

Referring back to FIG. 4, in step 200, a three-dimensional seismic volume creation algorithm is executed on an appropriate compute platform to produce an image volume. The algorithm implemented to create an informed three-dimensional seismic volume based on collected microseismic data comprises the following primary steps: (a) defining a desired output volume with given extent, orientation and coordinate system to encompass a desired image target area; (b) initializing of all parameters with zero values; (c) for each input image slice or corridor in the local imaging coordinate system for the output volume, interpolating all values of input image slice or corridor at each of the local imaging grid points values onto the output volume grid values; (d) adding the interpolated values; (e) optionally applying amplitude weights to normalize the input volume (normalization equalizes image contributions that vary in relation to source magnitude of the microseismic events); (f) at each output grid point, accumulating the associated amplitude values; and (g) when all image contributions are added to the output volume, optionally applying an actual or smoothed hit count normalization.

The resulting image volume will be well sampled in regions where there are microseismic events, and less well sampled or zero in regions where there are few or no microseismic events present.

In step 300, optional processing may be performed on the resulting data and image volume. These optional processes include applying optional image smoothing 310 (depending on the offset from the observation well), applying optional data infill 320 (such as with other prediction error or data interpolation schemes), and applying optional image filtering to highlight geologic features 330 (for example, particularly useful filters may highlight geologic layer continuity, faults, and/or brittle/ductile zones).

In step 400, a final three-dimensional seismic volume is generated. In step 500, the final three-dimensional seismic volume may be analyzed and interpreted, typically by using standard seismic interpretation methods and software.

In step 600, a final three-dimensional seismic volume image may be rendered for viewing by a user. This rendering may be as a digital image on a computer screen, as an image printed on paper, or any other visual medium. Images may be co-rendered and analyzed together with, for instance, seismic event clouds, surface seismic data, well logs, anisotropy logs, vertical seismic profile data, and flow measurements. Images may be analyzed for, for example, brittle and ductile zones, efficiency of fracturing zones and stages, small scale faulting/folding, and fracturing pathways. Flow measurements can be calibrated to image at the stage location and then extrapolated further away from the treatment borehole.

Note that the method 10 is described herein as assuming that the acquisition of seismic wave field data is carried out concurrently with continuous processing of the acquired data according to one exemplary application of the interferometric method 10 according to the invention. Continuous and concurrent data processing supports the application of the method 10 to a hydraulic fracturing operation in real-time to allow the method 10 to be used to monitor the hydraulic fracturing operation and possibly modify certain operational parameters associated with the ongoing fracturing operation, e.g., pump pressure and/or fracture fluid flow rate. However, the method may be applied to pre-existing data. Additionally, a first party may apply the method 10 to data acquired by a separate party.

Now, in greater detail, the flowchart of FIG. 5 depicts steps associated with the implementation of the three-dimensional seismic volume creation algorithm 200 of the interferometric method 10. In step 202, for each microseismic event, a P wave arrival is detected; in step 204, for the same microseismic event, a corresponding S wave arrival is detected.

Referring to FIG. 6, a plot for a plurality of P wave and S wave arrival times is shown. FIG. 6 provides an exemplary plot of traces associated with picking and modeling the arrival times of P waves and S waves, which is performed to determine the location of each event. The P wave and S wave field arrivals are uniquely identified. In some instances, the P wave and S wave fields may be enhanced by signal filtering to suppress noise in the signal. In addition to the initial P wave or S wave arrival, scattered wave field components are identified. These scattered wave field components contain information about the subsurface geology and can be important to include in further processing, while other noise signals are excluded.

In one example, the P wave and S wave arrival times are picked and then subsequently modeled. For example, in FIG. 6, we illustrate a plot of picked P wave field arrival times 22 and associated modeled P wave field arrival times 24. The correlation between the picked and modeled arrival times provides an assessment of the validity of the picked P wave arrival times 22. An equivalent process is applied to picked S wave arrival times and modeled S wave arrival times. Ensuring accuracy of the wave arrival times is desirable since the distance from each microseismic event location to the location of each sensor is in part determined according to the P wave and S wave arrival time picks. The event location is also determined by orientation visualized by azimuth and dip of the line connecting the event to the sensor, which is determined from hodogram analysis.

From the P and S wave arrival's particle motion polarization of each sensor 12, the most likely azimuth for the direction of a wave field arrival is estimated and an azimuth window is determined. This information is combined with a three-dimensional velocity model to determine an estimated location of a microseismic event 30 and its associated spatial uncertainty.

The method 10 of the present invention goes beyond conventional practice and uses the microseismic wave field data to image the surrounding geologic structure. Identification of the location of a seismic event 30 is a limited indicator of the formation's response during and after a fracturing operation and provides limited insight into the complexity of the formation, the artificially induced fractures and flow regimes and the anticipated behavior of the reservoir.

Referring once again to FIG. 5, in step 210, the P wave field and S wave field associated with each event may be enhanced to maximize P and S energy of those arrivals. In step 215, a P wave field and an S wave field arrival window for an event are selected to include both scattered and reflected energy.

In step 220, from arrival polarization information obtained at each sensor, a most likely event azimuth is computed via hodogram analysis, energy maximization or eigenvalue analysis. A hodogram analysis consists of a cross plot of two components of particle motion over a time window. Hodograms are used in borehole seismology to determine arrival directions of waves and to detect shear-wave splitting.

In step 225, an associated azimuth window is determined by computing the maximum likelihood arrival direction and its angular uncertainty, resulting in a single azimuth or a probability weighted azimuthal segment. Optionally, in step 227, an event location may be estimated using travel time and particle motion information. In step 230, a high-resolution three-dimensional velocity model is created by calibrating, up-scaling and horizon/formation guided lateral extrapolation of velocity values, whereby using all available information, such as well logs, vertical seismic profile, surface seismic data, formation tops, and/or horizons, including microseismic event information (tomographic velocity inversion of P and S event arrival times)

In step 235, a three-dimensional computational grid is generated comprising one (in this example) vertical axis (along the sensor array), a second axis pointed towards the estimated azimuthal direction and a third axis perpendicular to both the first axis and the second axis. The extent and spacing of the computational grid is optimized using anisotropic dispersion minimization, accuracy maximization, and boundary artifact minimization criteria, based on minimum and maximum velocities and maximum frequencies in the P and S seismic data, in order to ensure the desired level of accuracy and speed of computation.

Where extensive compute resources are available, as in server farms, or, via cloud computing, the extent and spacing of the computational grid may be enhanced to obtain results that are more resolute. Extended compute capability associated with smaller but more powerful computer resources allows the analyses associated with application of the interferometric method 10 to be performed in the field in near real time to produce relevant images during the course of a hydraulic fracture program to guide decisions during the program.

Conveniently, two separate computational domains are used: one for P waves and one for S waves. A convenient zero time reference is defined at the minimum P wave arrival time. In step 240, depending on the extrapolation equation algorithm chosen, selected or all components of the P wave and S wave fields are injected into the computational grid. In step 250 wave fields are extrapolated in the respective computational domain from the locations of the sensors 12 and propagated laterally away from the sensor locations, starting at the zero time until the end of time window is reached or the end of recording is reached.

P-wave and S-wave fields are propagated with the propagation direction essentially perpendicular to the receiver array 13. Propagation is carried out using any of: (a) a wave equation migration algorithm 252 using an acoustic wave equation, using scalar wave fields (PSPI, PSPC, SplitStep or others); (b) finite difference propagation 254 with acoustic or elastic wave equations using scalar, vector or tensor wave fields; or (c) integral wave equation 256.

As propagation proceeds (wave field extrapolation towards the event location), an interferometric imaging condition between P and S wave fields is applied in step 260 at each grid point in the computational domain. The imaging condition can be a correlation for low signal-to-noise ratio data or a deconvolution for high signal-to-noise ratio data. Since no absolute source time is known, the P wave and S wave fields are used to provide an image using interferometric imaging conditions of P wave and S wave field components at each grid point of the computational domain. Where the P wave and S wave field components coincide and a stationary phase condition is observed, the coinciding scattering potential will be large and a large amplitude value is observed. A large amplitude value can also be observed at not only the actual source location, but also where diffraction points or reflection points convert energy from P to S during the original propagation in the subsurface. In this manner, points where the transmitted wave fields are scattered or reflected from the surrounding geology may be determined.

Still referring to FIG. 5, in step 265, source and receiver radiation patterns can be compensated for a-priori or in the imaging process. In step 270, P wave and S wave fields are imaged towards the origin location of the microseismic event 30. The propagation will incorporate internal reflections, diffractions and other effects, which will image the event 30 and secondary scattering sources under different radiation angles.

The interferometric method 10 described herein does not require explicit knowledge of the microseismic event origin time; the P and S travel time difference and wave field consistency are the more important quantities. However, the interferometric method 10 according to the invention preferably involves both P waves and S waves being detectable by the sensor array 13. In step 275, proper orientation of the planar image slice within an arbitrary output image volume is computed using the estimated event location. Orientation is based on planar image slice orientation with respect to the three-dimensional coordinate system associated with the aggregate output image volume 20.

Referring to FIG. 7, each microseismic event 30 produces data that ultimately may be used to create a planar image slice 50 of the subsurface. The planar slice 50 is aligned with the estimated azimuth of the microseismic event 30 between the microseismic event 30 location and the sensor array 13 deployed in an observation well 40.

For a single downhole vertical array 13, if many microseismic events occur in the subsurface, the recorded data from each can be processed to produce an image 50 at its particular azimuthal direction. A multitude of microseismic events produces a multitude of azimuthally orientated image slices. For a typical microseismic event set consisting of several thousand microseismic events, all of the arbitrarily oriented image contributions can be summed to form one three-dimensional image volume in step 280.

In practical application, there are further steps that are preferably taken to obtain a three-dimensional subsurface image. In step 285, amplitude scaling of individual image slices is performed to equalize or normalize the source energy of the event wave field. Generally, the resulting three-dimensional image volume 20 will have regions without an image, where no nearby events existed to cover that area. Spatial smoothing that depends on the offset from the observation well 40 can be applied, or the data may be infilled or interpolated with prediction error minimization or other missing data estimation schemes. Since the imaging procedure naturally exhibits a strong footprint and the interferometric imaging geometry accentuates certain scattering features, three-dimensional image volume filtering, such as dip filters, F-K filters, steering filters, and other filtering methods may be applied to highlight various geologic features, such as geologic layer continuity, faults, and brittle/ductile zones.

Having thus created the three-dimensional image volumes 20 using the interferometric method 10 according to the present invention, the resulting images may be interpreted and analyzed with known seismic interpretation software. The frequency content of the images is driven by the frequency range of the microseismic data as recorded in the downhole sensors 12. Depending on sensor sensitivity, the typical frequency range or bandwidth is several hundred hertz—much higher than comparable surface seismic or vertical seismic profile (VSP) data bandwidth. The resulting images can be co-rendered and analyzed with seismic event clouds, surface seismic data, well logs, anisotropy logs, VSP data or flow measurements. In particular, the resulting images can be used to evaluate brittle ductile zones, efficiency of fracturing zones and stages, or small scale faulting/folding and fracturing pathways.

Flow measurements in the borehole at perforation locations during a fracture operation can be calibrated to the generated image at each fracturing stage location. This calibration can then be extrapolated further away from the borehole to characterize and quantify the flow behavior during the hydraulic fracturing operation.

The interferometric imaging of microseismic events 30 recorded on suitable downhole sensor arrays 13 according to the invention enables the creation of high-resolution subsurface image volumes 20 of each fracture zone. Unlike other methods, the method 10 of the present disclosure does not require knowledge of overburden acoustic velocities. Only local velocity information is required, which can be obtained from auxiliary data (e.g. vertical seismic profiling, check shot surveys, well logs, a-priori models), or from microseismic event data themselves. The method 10 of the present disclosure supports time-lapse analysis of interferometric images on a stage-by-stage basis, consistent with the extent of the image coverage associated with each fracturing stage or zone.

The method 10 according to the invention is not restricted to application for the analysis and development of unconventional oil and gas resources, where fracturing operations are required to create economic production. The method 10 likewise applies to analysis and modeling of any reservoir, including conventional oil and gas resources, CO2 sequestration, geothermal energy and solution mining where sufficient oilfield noise is present to provide seismic energy to illuminate the reservoirs via the recorder array(s) and application of the method 10 of the present invention.

Still referring to FIG. 7, an exemplary image of planar slice 50 created via application of the method 10 is illustrated. As previously described, the method 10 creates a planar slice 50 defined by a specific microseismic event 30 and a borehole array 13 deployed in an observation well 40. The planar slice 50 provides high-resolution definition of the local formation disposed between the borehole array 13 in the observation well 40 and the location of the microseismic event 30.

In accordance with the interferometric method 10, P waves and S waves for each microseismic event 30 are selected and propagated from one or more observation wells 40, 42, 44, 46 toward the microseismic event location 30. Where P and S wave energies coincide, an image is formed. For each microseismic event 30, a plane 50 is imaged containing the event location 30 and the observation well 40 containing the borehole sensor array 13. Multiple image planes 50 associated with a single microseismic event 30 and multiple receiver wells 40 can be combined to develop a three-dimensional volume image 20. With a wide distribution of source points, a three-dimensional image volume 20 is built in accordance with the three-dimensional volume creation algorithm 200 of the method 10.

FIG. 8 is an illustration of a second single image plane 51 derived from a second single microseismic event 32 and a sensor array 13 in the same observation well 40.

Referring now to FIG. 9A, we illustrate that multiple planar images associated with a plurality of planar slices 50, 52, 54, 56 generated from a single microseismic event 30 can be aggregated to create a desired three-dimensional volume. The associated geologic features captured within each of the planar slice images 50, 52, 54, 56 will sum together consistently, while random noise inconsistent with the geologic features will be suppressed since those same geologic features may be illuminated and imaged by different microseismic events.

Likewise, referring to FIG. 9B, we illustrate that multiple image corridors 57, 58 can be generated based on one or more wave field data sets from a single microseismic event 30 recorded in corresponding observation wells 47, 49. As with planar image slices, the corridors 57, 58 can be aggregated to create a desired three-dimensional seismic image volume 20. The associated geologic features captured within each of the corridors 57, 58 will sum together consistently, while random noise inconsistent with the geologic features will be suppressed since those same geologic features may be illuminated and imaged by different microseismic events.

Throughout the remainder of this description, references to the creation or use of planar image slices are likewise applicable to three-dimensional corridors. For simplicity and understanding, the application of the interferometric method 10 is described with reference to planar image slices.

FIG. 10 is a further illustration of the application of the method 10 where observation wells are resident within stacked reservoirs. Once again, the wave field associated with a single microseismic event 30 can be captured and recorded by a plurality of sensor arrays 13 in (a) a plurality of observation wells 40, 42, 44, 46 in a first reservoir, and (b) a plurality of observation wells in a second reservoir 70, 72, 74. In this aspect, the interferometric method 10 is applied to create multiple image planes in an upper reservoir and multiple image planes 80, 82, 84 in a lower reservoir derived from the single microseismic event 30. The plurality of image planes 50, 52, 54, 56, 80, 82, 84 can once again be aggregated to create a three-dimensional volume 20 of greater extent.

Although shown herein as applicable to two stacked reservoirs, the method may be extended to application in more complex reservoir geometry, having multiple zones or reservoirs. The extensibility and scalability of the method supports an ability to process disparate microseismic events to gain a more granular understanding of the reservoir characteristics and geologic features in an area of interest.

In another aspect, FIG. 11 is an illustration of the application of the method 10 to create cross-well interpretation of the subsurface formation from a cross-well image constructed interferometrically. Here, the method 10 creates an image plane 65 derived from a single microseismic event 34 to create a cross-well interpretation based on a virtual cross-well data set. Sensor arrays 13 are deployed in both wellbores 62, 64. In this particular application, both the microseismic event 34 and the wellbores 62, 64 are preferably substantially located in a common plane.

Where two or more boreholes with sensor/receiver arrays are used to collect wave field data, the virtual source approach (interferometry concept) can be applied to construct a cross-well seismic dataset with very high resolution. The newly constructed virtual cross-well data set contains virtual sources at each of the sensor locations in the boreholes 62, 64. This data set is processed as if a real down-hole source data set had been collected with the same source frequency characteristics as the microseismic event 34. Traditional borehole seismic processing, such as filtering, wave field separation, source deconvolution and pre-stack imaging may be applied to obtain a cross well planar image slice 65.

In still another aspect, FIG. 12 is an illustration of the application of the method 10 wherein intersecting image planes 94, 96 may be derived from a single microseismic event 38. In this version, sensor arrays 13 are deployed in non-parallel wellbores 90, 92. Separate planar slices 94, 96 are generated according to the method 10 for each observation well 90, 92 based on the single microseismic event 38. Where planar slice 94 intersects with planar slice 96 to create an overlap of data along the intersection 98, the method 10 is able to provide a more resolute image with the correlated data to enhance interpretation of the three-dimensional seismic image volume 20.

In addition to the various deployment scenarios described above, the interferometric method 10 supports analysis of time-lapse effects, e.g., features that have changed at different fracturing stages or at differing stages of steam flood, water flood, reservoir depletion and other time-based subsurface changes.

In addition to data gathered via the use of geophones, leveraging the method 10 of the present invention, distributed downhole fiber optic sensors can provide a long-term solution to allow tracking of reservoir activity throughout the life of one or more well(s) based on periodic or continuous microseismic monitoring. In one version, fiber optic sensors may be permanently embedded within cemented portions of a well, particularly where the observation well is vertical and perpendicular to a substantially horizontal production bore used for fracturing operations. With distributed fiber optic sensing, by analyzing the laser light reflections from different spots in the fiber, the temperature and strain of the glass can be determined at any point in the well, and the fiber itself can serve as a series of distributed seismic sensors. Thus, the integration of distributed fiber optic sensors as signal receivers in support of the interferometric method 10 described herein can create an even higher resolution subsurface image due to the ability to have a larger spatial extent while simultaneously providing closer spacing between the fiber optic sensors as compared to standard geophones. The higher sample density using distributed fiber optic sensing, in combination with the interferometric method 10, allows illumination of seismic events, including microseismic events, that might remain unseen to standard geophones. In addition, the interferometric method 10 of the present invention as applied to a highly granular fiber optic sensor array can support enhanced control of actual hydraulic fracturing operations in real-time to assess the distribution and placement of fracture fluid and proppant by monitoring microseismic events throughout the fracturing operation.

The method 10 described herein can be performed using computers and data processors. The data described herein can be stored on computer-readable media. Furthermore, the method 10 described herein can be reduced to a set of computer-readable instructions capable of being executed by a computer processor, and which can be stored on computer readable media. Alternatively or in addition, the computer-readable instructions can be encoded on an artificially generated propagated signal, e.g., a machine-generated electrical, optical, or electromagnetic signal that is generated to encode information for transmission to suitable receiver apparatus for execution by a data processor.

The processes and logic flows described herein can be performed by one or more programmable processors executing one or more computer programs to perform actions by operating on input data and generating output. The processes and logic flows can also be performed by, and apparatus can be implemented as, special purpose logic circuitry, e.g., a FPGA (field programmable gate array) or an ASIC (application specific integrated circuit).

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth herein and the appended claims.

1. A method for interferometric microseismic imaging of the Earth's subsurface, comprising:
(a) taking a data set corresponding to a recording by a sensor array of a microseismic event wave field generated by a microseismic event in the subsurface; and
(b) processing the data set to generate a microseismic image slice for at least one microseismic event wave field;
wherein said processing comprises:
identifying arrival of a P wave and arrival of an S wave in the microseismic event wave field and forming a respective P wave field and an S wave field; and
propagating the P wave field and S wave field away from the location of the sensor array and applying an interferometric imaging condition between the P wave field and the S wave field at a plurality of grid points to form an image of the subsurface.

2. The method of claim 1 further comprising enhancing the P wave field and S wave field by signal filtering.

3. The method of claim 1 further comprising estimating a likely event azimuth wherein estimating a likely event azimuth comprises computing a most likely event azimuth from arrival polarization information.

4. (canceled)

5. The method of claim 3 further comprising the step of estimating a microseismic event location.

6. The method of claim 5 wherein the microseismic event location is estimated using travel time and particle motion information.

7. The method of claim 5 wherein the microseismic event location is estimated based on the times of arrival of the P wave and the S wave and a velocity model.

8. The method of claim 3 comprising generating a three-dimensional computational grid based on the location of the sensor array and the likely event azimuth.

9. The method of claim 8 wherein the step of propagating the P wave field and S wave field away from the location of the sensor array comprises injecting one or more components of the P wave field and the S wave field into the three-dimensional computational grid and extrapolating the P wave fields and the S wave fields in respective computational domains from the locations of the sensor array and wherein the interferometric imaging condition is applied between the P wave field and the S wave field associated with each grid point in the computational domain.

10. The method of claim 1 wherein propagation of the P wave field and the S wave field comprises starting with data corresponding to a zero time and propagating the P wave field and the S wave field until an end of time window is reached or an end of recording is reached.

11. The method of claim 1 wherein propagating the P wave field and the S wave field is carried out using any of:
(a) a wave equation migration algorithm using an acoustic wave equation, using scalar wave fields;
(b) finite difference propagation with acoustic or elastic wave equations using scalar, vector or tensor wave fields; and
(c) integral wave equation.

12. The method of claim 1 wherein the data set comprises a recording of an microseismic event wave field for each of a plurality of microseismic events and the method comprises generating an image slice based on each of microseismic event wave fields.

13. (canceled)

14. The method of claim 12, comprising combining the image slices to form a three-dimensional image volume wherein combining the image slices comprises the steps of:
(a) defining a desired output volume with a given extent, orientation and coordinate system to encompass a desired image target area;
(b) for one or more image slices in the local imaging coordinate system for an output volume, interpolating all values of the one or more input planar image slices at each of the local imaging grid points values onto the output volume grid values;
(c) adding the interpolated values; and
(d) at each output grid point, accumulating the associated amplitude values.

15. The method of claim 14, further comprising the step of applying amplitude weights to normalize the output volume.

16. The method of claim 14, further comprising the step of applying an actual or smoothed hit count normalization when all image contributions are added to the output volume.

17. The method of claim 14, further comprising the step of performing amplitude scaling on the image slices to equalize or normalize the source energy of the event wave field.

18. The method of claim 1, wherein the microseismic event wave field is defined by measurement of any of:
(a) one or more displacement/velocity/acceleration components;
(b) one or more pressure components; and
(c) one or more strain components/strain rate components.

19. The method of claim 1, wherein the microseismic event wave field is measured by any of one or more scalar sensors and one or more vector sensors of the sensing array.

20. The method of claim 19 wherein the one or more scalar sensors are hydrophones for measuring pressure components of the wave field and the one or more vector sensors are geophones for measuring one or more displacement/velocity/acceleration components of the wave field.

21. (canceled)

22. The method of claim 19 wherein the sensing array comprises a fiber optic distributed sensor for measuring strain rate components and strain components of the wave field.

23. A computer readable medium having a computer program thereon, the computer program having logic operable to cause a programmable computer to perform the method of claim 1.

24. A microseismic imaging apparatus comprising:
a memory for storing a data set corresponding to a recording by a sensor array of a microseismic event wave field generated by a microseismic event in a subsurface area of interest; and
a processor configured to processing the data set to generate a microseismic image slice for at least one microseismic event wave field;
wherein said processing comprises:
identifying arrival of a P wave and arrival of an S wave in the microseismic event wave field and forming a respective P wave field and an S wave field; and
propagating the P wave field and S wave field away from the location of the sensor array and applying an interferometric imaging condition between the P wave field and the S wave field at a plurality of grid points to form an image of the subsurface.

25. A system for interferometric microseismic imaging of the Earth's subsurface comprising:
microseismic imaging apparatus as claimed in claim 24; and
and at least one sensor array having an array of sensing elements deployed in borehole in the subsurface area of interest to record said data set.

26-27. (canceled)

28. A method for interferometric microseismic imaging of the Earth's subsurface, comprising:
(a) using one or more sensors to record a microseismic event wave field;
(b) creating a data set based on the recording of the microseismic event wave field;
(b) applying an interferometric three-dimensional seismic volume creation algorithm to the data set; and
(d) generating a three-dimensional seismic volume.

29. The method of claim 28, wherein the three-dimensional seismic volume creation algorithm further comprises the steps of:
(a) for a plurality of microseismic events, detecting a P wave and an S wave arrival using one or more sensors;
(b) selecting a P wave field arrival window and selecting an S wave field arrival window for each of the plurality of microseismic events;
(c) computing a most likely event azimuth from information obtained at each one or more sensors;
(d) determining an azimuth window;
(e) determining an event location;
(f) creating a three-dimensional velocity model;
(g) generating a three-dimensional computational grid;
(h) injecting one or more components of the P wave field and the S wave field into the three-dimensional computational grid;
(i) extrapolating the P wave fields and the S wave fields in the respective computational domains from the locations of the sensors and propagating the P wave fields and S wave fields laterally away from the sensor locations, starting at a zero time until an end of time window is reached or an end of recording is reached;
(j) applying an interferometric imaging condition between the P wave field and the S wave field associated with each grid point in the computational domain;
(k) propagating the P wave field and the S wave field;
(l) imaging the P wave field and the S wave field towards each origin location of the plurality of microseismic events, generating a plurality of image slices;
(m) computing a proper orientation of each of the plurality of image slices within an arbitrary output image volume; and
(n) summing all of the plurality of image slices to form a three-dimensional image volume.

30-31. (canceled)
